(19) United States
(12) Patent Application Publication
(10) Pub. No.: US 2010/0146435 A1
(43) Pub. Date: Jun. 10, 2010

(54) METHOD AND SYSTEM FOR NAVIGATING THROUGH PARTS OF A DOCUMENT

(76) Inventor: JEAN-CHRISTOPHE CROS, Paris (FR)

Correspondence Address: SAP AG, 3410 HILLVIEW AVENUE, PALO ALTO, CA, 94304, US

(21) Appl. No.: 12/327,815

(22) Filed: Dec. 4, 2008

(51) Int. Cl. G06F 3/048

(52) U.S. Cl. 715/786

(57) ABSTRACT

Described herein is a user interface with a scroll line, comprising a plurality of segments. Each segment points to a unique part in a document identified by a unique identifier. The scroll line underlines the unique identifier of a current part being displayed in a viewable area. A scroll element is provided on the scroll line operable to navigate between parts of the document by moving it across the segments. Each position of the scroll element on the scroll line selects exactly one segment. The scroll element is positioned at a segment on the scroll line pointing to the current part. Selecting and dragging an image of the scroll line away from a current position of the scroll line changes the information being displayed about the scroll line based on the distance between the current position of the image scroll line and an initial position of the scroll line.

### TECHNICAL FIELD

Embodiments of the invention generally relate to computer systems, and more particularly to a method and system for navigating through parts of a document. BACKGROUND

A graphical user interface is a type of display format that enables a user to choose commands, start programs, and see lists of files and other options by pointing to pictorial representations and lists of menu items on a computer display screen. Choices can generally be activated by either a keyboard or a pointing device such as a mouse. Graphical user interface environments rely on icons, which are small graphic images displayed on the computer display screen to represent objects that can be manipulated by a user.

For application developers, a graphical user interface offers an environment that can handle direct interactions with the computer. Such environments free the developer to concentrate on a given application without becoming entangled in the details of a screen display or mouse and keyboard input. A graphical user interface also enables programmers to create programs to handle frequently performed tasks, such as saving a data file. The interface itself provides standard controlling mechanisms such as windows and dialog boxes. Another benefit of graphical user interfaces is that applications written for graphical user interfaces are device independent: as the graphical user interface changes to support new input and output devices, such as a large screen monitor or an optical storage device, the applications can, without modification, use those devices.

Some conventional graphical user interfaces provide a cursor and scrollbar for scrolling through parts of a document with each part corresponding to a page in the document. In many types of graphical user interfaces, a vertical or horizontal bar at the side or bottom of a graphical user interface window can be utilized in conjunction with a pointing device such as a mouse, trackball, or stylus well known in the art of graphical user interface for moving about in a compound document. Scrolling permits viewing of any desired portion of a document and is so named because it is the electronic equivalent of reading through a rolled (i.e. scrolled) document rather than flipping through pages of a book. A computer keyboard provides a number of arrow keys. Application programs often offer additional methods of scrolling for example, combining the “control” and “page up” keys to move to the beginning of a document. A cursor in a graphical user interface environment is usually a specialized on-screen indicator, such as a blinking underline or rectangle, that marks the place at which keystrokes appear when typed.

Scroll bars are typically utilized in graphical user interface environments to accomplish scrolling tasks. A vertical or horizontal bar at the side or bottom of a window that can be used with a mouse for moving around in a document can be utilized in a typical scrolling task. For example, commercially available software word-processing programs typically use two scrollbars for scrolling through pages of a document. A vertical scrollbar is usually utilized to control movement or to scroll through lines and pages of a document, while a horizontal scrollbar controls movement through words in a line.

Such conventional scrollbar systems usually comprise two arrows and a slider. Each arrow controls the direction in which a user desires to scroll through a document. An arrow conventionally controls movement through a document in small increments or small blocks of information, such as individual lines or a page of a document, for example. Moreover, if an arrow points in the upward direction, the document will be scrolled from its present position in the document towards the first page. If an arrow points in the downward direction, the document will be scrolled from its present position in a document towards the last page of the document.

A slider is conventionally used to control movement through a document in larger increments than when the arrows are used. A slider is one form of a graphical user interface icon. Instead of incrementing by small blocks of information, the slider typically controls movement through a document in larger blocks, increments, or groups of information, such as two or more pages, for example. Therefore, when a user desires to go from the first page to the fiftieth page, the slider is usually selected and moved until page fifty is selected. The term “elevator” is also utilized to describe such a slider. A limitation of a scrollbar is that a user is not able to view the entire range of pages in a document. The only way to find out the length of the document is by navigating the entire length of the document. Another limitation of a scroll bar is that the user does not have any clue of the content of any of the pages in the document without scrolling to the page. Furthermore, the scrollbar does not allow direct navigation from one page to another page in a document without scrolling through all the intermediate pages.

Some graphical user interfaces provide hyperlinks for enabling navigation between pages such as pages of a document or web pages. A hyperlink is typically a graphic or a piece of text in an Internet document that can connect readers to another webpage, or another portion of a document. Web users usually find at least one hyperlink on every webpage. The simplest form of hyperlinks may be found as embedded text or an embedded link. A hyperlink typically shows up as a single word or group of words that usually are marked as underlined, and are frequently blue in color. Clicking on the hyperlink may take one to another part of the page, or it may open another Internet page. There are no graphical user interfaces available that combine the functionalities of the scroll bar and the hyperlink to provide the user easier navigation and an enhanced user experience.

### SUMMARY OF THE INVENTION

Embodiments of the invention are generally directed to a method and system for navigating through parts of a document. A user interface with a scroll line comprising a plurality of segments is provided. Each segment points to a unique part in a document with each of the unique parts being identified by a unique identifier. The scroll line underlines the unique identifier of a current part being displayed in a viewable area. At least one scroll element is provided on the scroll line. The scroll element being operable to navigate between parts of the document by moving it across the segments with each position of the scroll element on the scroll line selecting exactly one segment. The scroll element is positioned at a first segment on the scroll line with the first segment pointing to the current part. A first user action comprising selecting and dragging an image of the scroll line away from a current position of the scroll line is received. The information being displayed about the scroll line is changed based on the distance between the current position of the image scroll line and an initial position of the scroll line. A second user action comprising selecting at least a portion of the displayed information is received. A new part is displayed in the viewable area based on the selection.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a pictorial representation of a graphical user interface window having a scroll line control according to an embodiment of the invention.

FIG. 2 is a pictorial representation of a graphical user interface window illustrating navigation between two pages of a document using a scroll line control according to an embodiment of the invention.

FIG. 3 is a pictorial representation of a graphical user interface window illustrating a zoom feature using a scroll line control according to an embodiment of the invention.

FIG. 4 is a pictorial representation of a graphical user interface window illustrating navigation through a hierarchical data structure using a scroll line control according to an embodiment of the invention.

FIG. 5 is a pictorial representation of a graphical user interface window illustrating navigation through the elements of a breadcrumb navigation using a scroll line control according to an embodiment of the invention.

FIG. 6 illustrates a logic flow diagram illustrative of operations for a graphical user interface which can be utilized in accordance with an embodiment of the invention.

FIG. 7 depicts a pictorial representation of a data processing system which can be utilized in accordance with an embodiment of the invention.

### DETAILED DESCRIPTION

Embodiments of the invention are generally directed to a method and system for navigating through parts of a document. A user interface with a scroll line comprising a plurality of segments is provided. Each segment points to a unique part in a document with each of the unique parts being identified by a unique identifier. The scroll line underlines the unique identifier of a current part being displayed in a viewable area. At least one scroll element is provided on the scroll line. The scroll element being operable to navigate between parts of the document by moving it across the segments with each position of the scroll element on the scroll line selecting exactly one segment. The scroll element is positioned at a first segment on the scroll line with the first segment pointing to the current part. A first user action comprising selecting and dragging an image of the scroll line away from a current position of the scroll line is received. The information being displayed about the scroll line is changed based on the distance between the current position of the image scroll line and an initial position of the scroll line. A second user action comprising selecting at least a portion of the displayed information is received. A new part is displayed in the viewable area based on the selection.

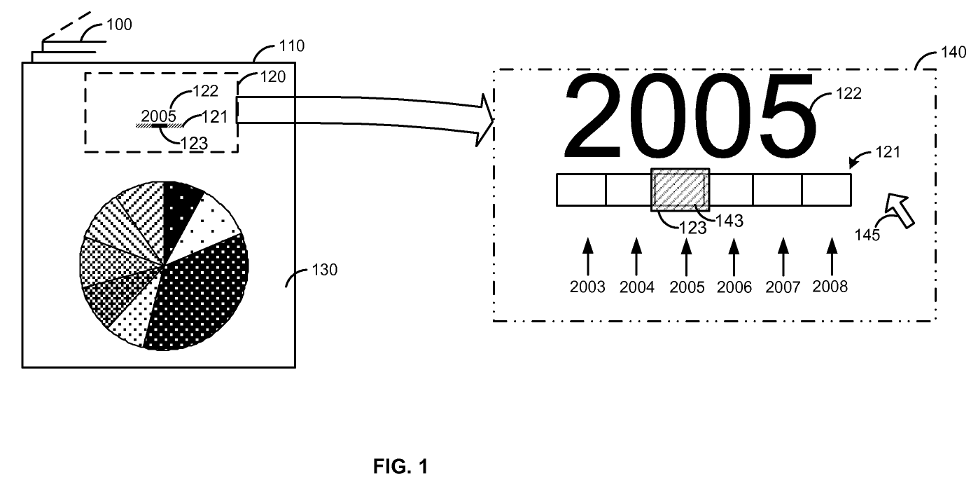

FIG. 1 is a pictorial representation of a graphical user interface window having a scroll line control according to an embodiment of the invention. Document 100 typically includes multiple parts. In an embodiment a part corresponds to a page 110 in the document 100. Page 110 includes a viewable area 130 and a user control area 120. User control area 120 provides control elements to the user for navigating through pages 110 of document 100. User control area 120 typically includes identifier 122, scroll line 121 which underlines identifier 122, and scroll element 123. Generally, identifier 122 uniquely identifies page 110. Every page 110 in document 100 is uniquely identified by an identifier 122. Viewable area 130 generally displays the content of page 110 identified by identifier 122. For example, viewable area 130 displays the content of page 110 identified by identifier 122 having value 2005.

Illustrative view 140 depicts user control area 120 zoomed in multiple times for better illustration of the control elements provided to the user for navigating document 100. Identifier 122 identifying page 110 is underlined by scroll line 121. Scroll line 121 is divided into two or more segments (e.g., 143) with each segment pointing to exactly one page 110 in document 100. The number of segments 143 is typically equal to the number of pages 110 in document 100. Scroll element 123 is designed to slide across segments 143 on scroll line 121. Each position of scroll element 123 on scroll line 121 selects exactly one segment (e.g., 143) and thus exactly one page 110 in document 100. The user may position a mouse cursor 145 over scroll element 123, click a pointing device (e.g., a mouse) and drag scroll element 123 to a segment to the right or left of scroll element 123 in order to navigate the document to page numbers higher or lower respectively than a current page 110. In an embodiment, the user may position mouse cursor 145 at any segment to the right or left of a current position of scroll element 123 and click a pointing device in order to move the scroll element to the right or left respectively one segment at a time, thus scrolling document 100 one page at a time. Each of the segments 143 is also associated with identifiers 122 of the respective pages 110 in document 100.

Typically user control area 120 always displays identifier 122 of a current page 110 being displayed in viewable area 130. Scroll element 123 is always positioned over a segment 143 pointing to the current page 110. As the user moves the position of scroll element 123 from a first segment to a second segment (by scrolling the scroll element 123 over the scroll line 121), the content in viewable area 130 changes from the content of the page 110 pointed at by the first segment to the content of the page 110 pointed at by the second segment. In addition, user control area 120 changes the display from identifier 122 associated to the first segment to identifier 122 associated to the second segment. The scroll line 121, after the change in position of scroll element 123, underlines identifier 122 associated to the second segment.

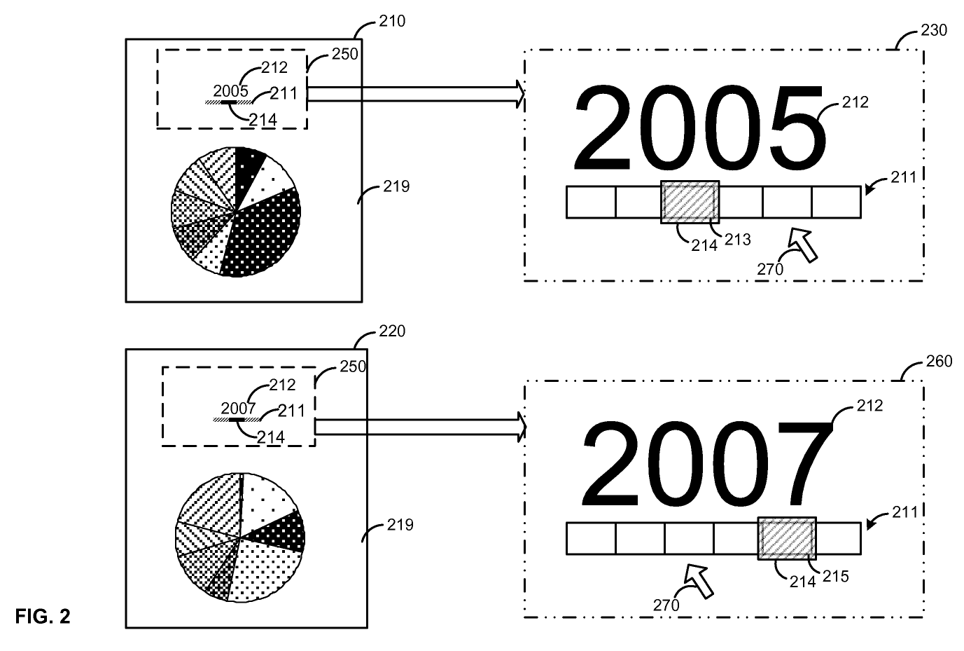

FIG. 2 is a pictorial representation of a graphical user interface window illustrating navigation between two pages of a document using a scroll line control according to an embodiment of the invention. More particularly FIG. 2 is an exemplary illustration of the navigation from page 210 to page 220 using scroll line 211. Illustrative view 230 depicts user control area 250 as displayed in page 210 zoomed in multiple times for better illustration of the control elements provided in user control area 250. Viewable area 219 displays the content of page 210 as identified by identifier 212 with value 2005. Segment 213 on scroll line 211 points at page 210 and is associated to identifier 212 with value 2005. Thus, in page 210, scroll element 214 is positioned at segment 213 on scroll line 211.

Illustrative view 260 depicts user control area 250 as displayed in page 220 zoomed in multiple times for better illustration of the control elements provided in user control area 250. In this exemplary illustration, a user changes the position of scroll element 214 (scroll) from segment 213 (as shown in illustrative view 230) to segment 215 (as shown in illustrative view 260). The user may change the position of scroll element 214 by placing mouse cursor 270 over scroll element 214, clicking a pointing device and dragging scroll element 214 to segment 215. In an embodiment, the user may position mouse cursor 270 at any position on scroll line 211 to the right of scroll element 214 and click a pointing device exactly two times to change the position of scroll element 214 over segment 215. As the position of scroll element 214 is changed to segment 215, the display in user control area 250 changes identifier 212 from value 2005 to value 2007. The content in viewable area 219 is consequently changed to the content of page 220 as identified by identifier 212 with value 2007.

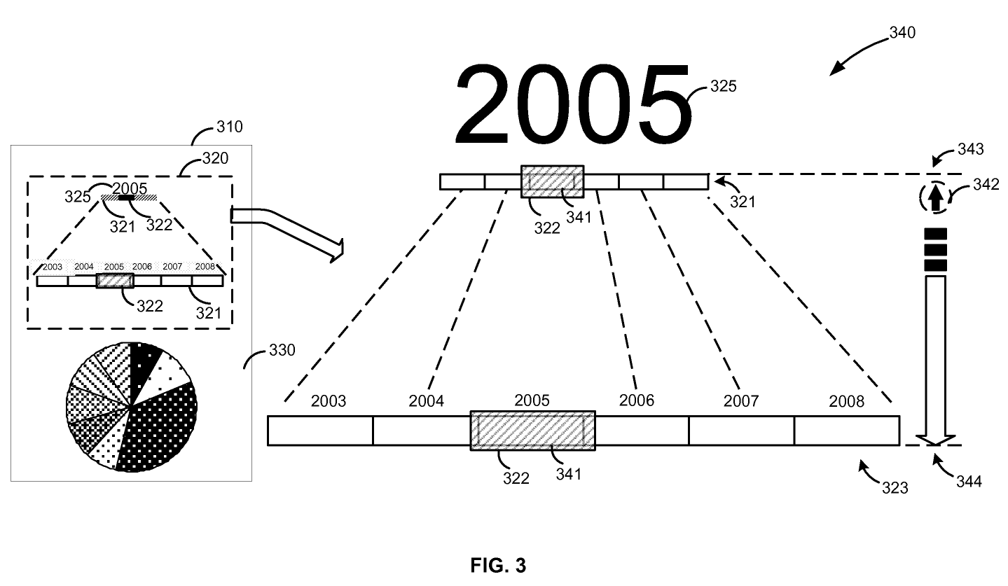

FIG. 3 is a pictorial representation of a graphical user interface window illustrating a zoom feature using a scroll line control according to an embodiment of the invention. Page 310 includes viewable area 330 and a user control area 320. User control area 320 includes identifier 325, scroll line 321 which underlines identifier 325 and scroll element 322. Viewable area 330 displays the content of page 310 identified by identifier 325. Identifier 325 typically displays a unique value for a current page 310 being displayed in viewable area 330. Scroll line 321 in conjunction with scroll element 322 is typically used for navigating through pages 310 of one or more documents.

Illustrative view 340 depicts user control area 320 zoomed in multiple times for better illustration of the control elements provided to the user in user control area 320. In an embodiment, user control area 320 provides zoom in and zoom out functionalities for scroll line 321. The user may zoom in or increase the display size of an image scroll line 323 by placing mouse cursor 342 on scroll line 321 at an initial position 343, clicking a pointing device and dragging scroll line 321 away from initial position 343 for example to position 344. Image scroll line 323 is typically displayed as soon as a user starts dragging scroll line 321 from initial position 343. In an embodiment, the display size of image scroll line 323 gradually increases as it is dragged away from initial position 343. As the user zooms into the scroll line 321, user control area 320 displays additional details including an entire range of navigatable identifiers with each identifier being placed right above or right below its respective segment 341 on the image scroll line 323. This feature provides an intuitive method for the user to express interest in additional details related to particular content of interest on the viewable area 330.

Alternatively, the user may also zoom out or decrease the display size of image scroll line 323 by placing mouse cursor 342 on image scroll line 323 at position 344, clicking a pointing device and dragging image scroll line 323 towards initial position 343, for example from position 344 towards initial position 343. In an embodiment, the display size of image scroll line 323 gradually decreases as it is dragged from position 344 towards initial position 343 until it merges with scroll line 321 at initial position 343.

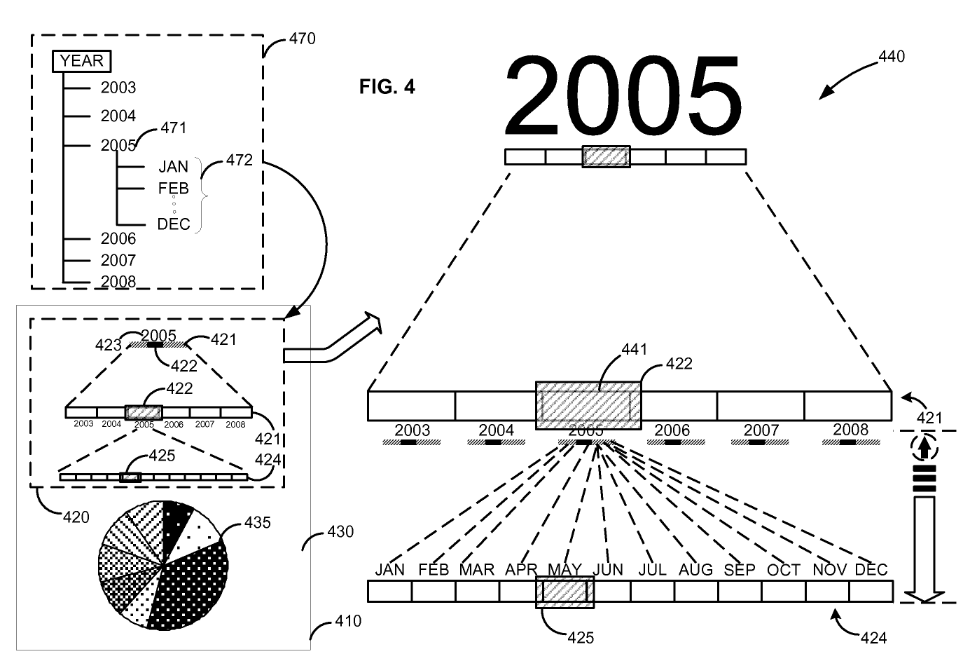

FIG. 4 is a pictorial representation of a graphical user interface window illustrating navigation through a hierarchical data structure using a scroll line control according to an embodiment of the invention. Page 410 includes viewable area 430 and a user control area 420. User control area 420 includes identifier 423, the scroll line 421 underlying the identifier 423 and a scroll element 422. Viewable area 430 displays the content of page 410 identified by identifier 423. Identifier 423 preferably displays a unique value for a current page 410 being displayed in viewable area 430.

Illustrative view 440 depicts user control area 420 zoomed in multiple times for better illustration of the control elements provided to the user in user control area 420. In an embodiment, user control area 420 enables navigation of data arranged in a hierarchical structure 470. Scroll line 421 may be used in conjunction with scroll element 422 for navigating through data in one of the primary nodes such as primary node 471. Each of the segments 441 in scroll line 421 point to a page 410 of data in primary node 471. For example, page 410 corresponds to segment 441 and displays the data for the year 2005 in viewable area 430, 2005 being the value of identifier 423 for page 410. Scroll line 424 may be used in conjunction with scroll element 425 for navigating through data pages in child nodes 472. User control provides zoom in and zoom out functionalities for both scroll lines 421 and 424 as discussed in FIG. 3.

In one alternative embodiment, selecting scroll line 421 may divide viewable area 430 into two or more sub-content areas. The number of sub-content areas may be equal to the number of segments 441 in scroll line 421 with each sub-content area being associated with exactly one segment 441. Scroll line 424 for each of the segments 441 in scroll line 421 may be zoomed in or expanded by dragging scroll line 424 away from its original position. As the scroll line gets dragged away it grows proportionally larger and as it grows, additional levels of hierarchical data become viewable as additional segments including their labels come into view, for instance. In one embodiment, as additional segments come into view the viewable content associated with them appears on the screen as well. This provides an intuitive way for a user to express interest in seeing additional levels of data and realizing it on the screen. This type of user interaction that is, dragging away from a current location is merely exemplary. Other interaction models are possible.

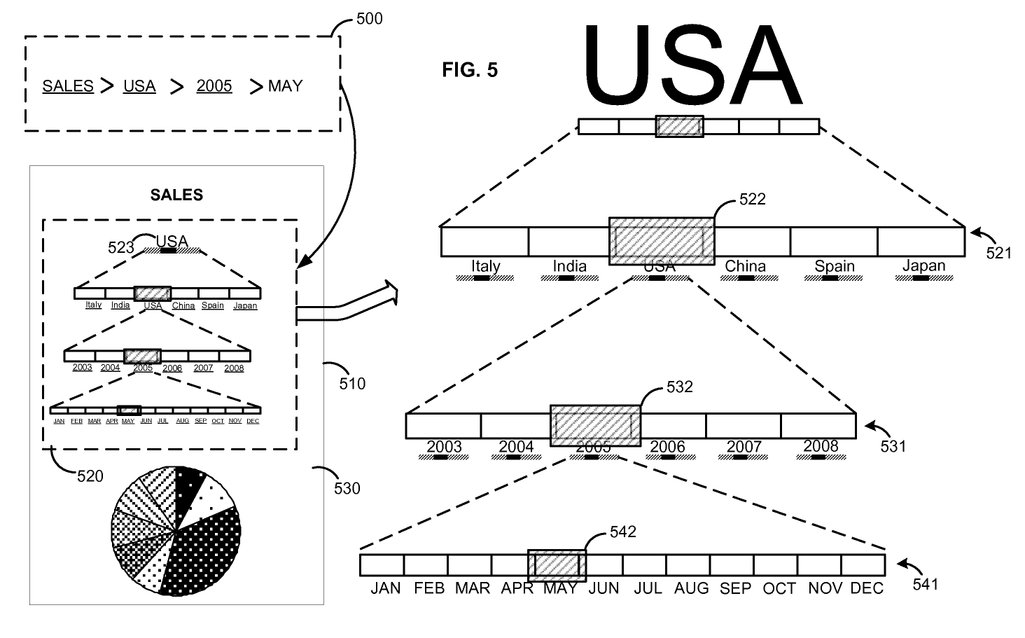

FIG. 5 is a pictorial representation of a graphical user interface window illustrating an exemplary navigation through the elements of a breadcrumb navigation using a scroll line control according to an embodiment of the invention. Breadcrumb navigation 500 represents the sales data for a company. Sales data as represented by breadcrumb navigation 500 is typically organized in a hierarchical tree structure. For instance, the first and topmost node in the hierarchy represents country wise sales data. The second node in the hierarchy represents sales data recorded in each year for every country. The third node in the hierarchy represents the sales data recorded for each month for a given country and year.

Page 510 includes viewable area 530 and a user control area 520. Viewable area 530 displays the content of page 510 identified by identifier 523. Identifier 523 typically displays a unique value for a current page 510 being displayed in viewable area 530.

As described in FIG. 1 through FIG. 4, scroll line 521 is used in conjunction with scroll element 522 for navigating through the elements in the first node of breadcrumb navigation 500. In other words, scroll line 521 in conjunction with scroll element 522 is used to navigate through the sales data of the company country wise.

Scroll line 531 is used in conjunction with scroll element 532 for navigating through the elements in the second node of breadcrumb navigation 500. In other words, scroll line 531 in conjunction with scroll element 532 is used to navigate through the sales data of the company in a particular year for each country.

Scroll line 541 is used in conjunction with scroll element 542 for navigating through the elements in the first node of breadcrumb navigation 500. In other words, scroll line 541 in conjunction with scroll element 542 is used to navigate through the sales data of the company in a particular month for a given country and year.

Typically as a user selects a segment 522, 532 or 542 on any of the scroll lines 521, 531 and 541 respectively, the value of identifier 523 changes to the identifier associated to the selected segment and viewable area 530 changes to display the data page being pointed at by the selected identifier.

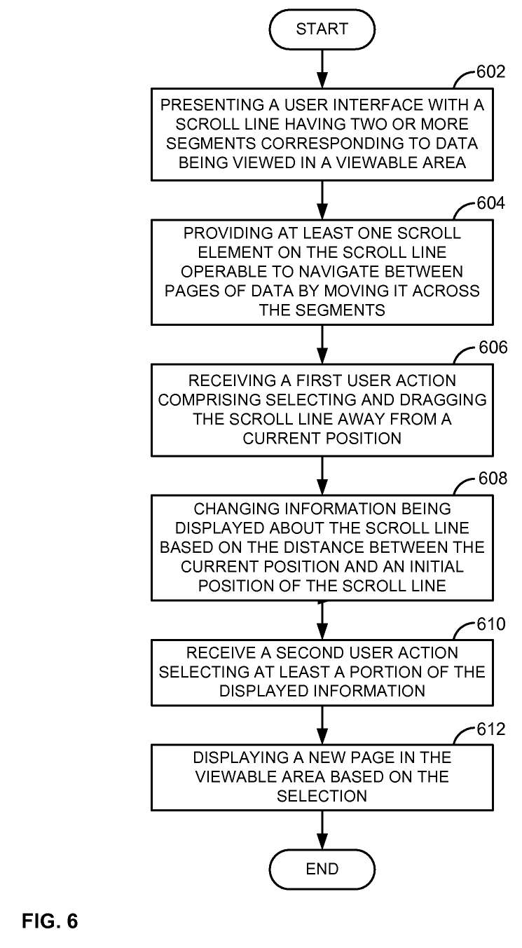

FIG. 6 illustrates a logic flow diagram illustrative of operations for a graphical user interface which can be utilized in accordance to an embodiment of the invention. In process block 602, a user interface with a scroll line (e.g., 321 of FIG. 3) having two or more segments (e.g., 341) corresponding to data being viewed in a viewable area is presented. The scroll line is typically divided into two or more segments with each segment pointing to a unique part in a document. Each of the unique parts of the document is identified by a unique identifier. The scroll line underlines the unique identifier of a current part of the document being displayed in a viewable area. In an embodiment a part corresponds to a page in the document. In process block 604, at least one scroll element is provided on the scroll line. The scroll element is operable to navigate between parts of the document by moving it across the segments. Each position of the scroll element on the scroll line selects exactly one segment. The scroll element is positioned at a first segment on the scroll line with the first segment pointing to the current part of the document. In process block 606, a first user action is received comprising selecting and dragging an image of the scroll line away from a current position of the scroll line. In process block 608, the information being displayed about the scroll line is changed based on the distance between the current position of the image scroll line and an initial position of the scroll line. In process block 610, a second user action comprising selecting at least a portion of the displayed information is received. In process block 612, a new part is displayed in the viewable area based on the selection.

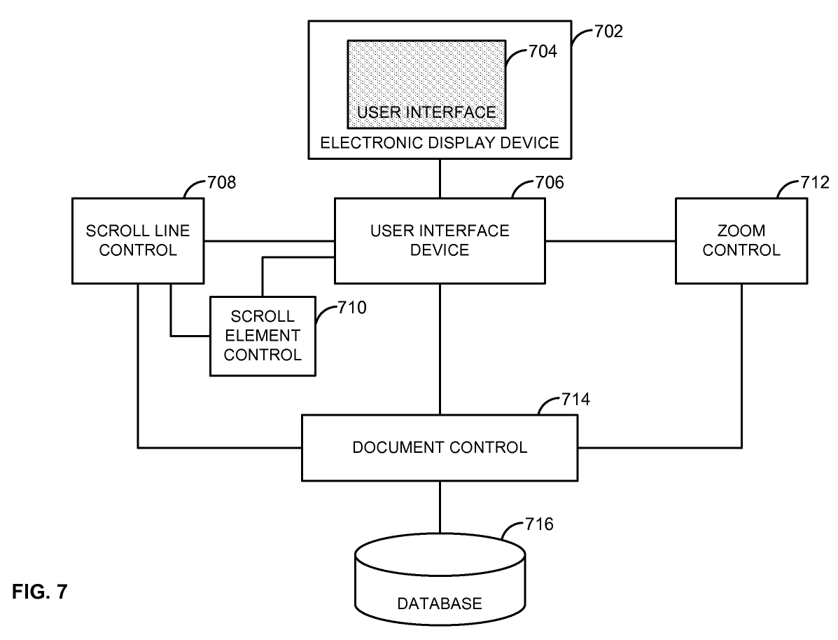

FIG. 7 depicts a pictorial representation of a data processing system which can be utilized in accordance to an embodiment of the invention. Electronic display device 702 typically displays user interface 704. User interface device 706 is typically responsible for interfacing with a user and for receiving user requests as user selections, and making changes to the display on user interface 704 based on the user selections. Scroll line control 708 provides a scroll line to be displayed on user interface 704. The scroll line is typically divided into two or more segments with each segment pointing exactly to one page in a document. The pages of the document along with the data on each of the pages are typically stored in database 716 and are accessible through document control 714. Each page in a document is uniquely identified by an identifier with user interface 704 displaying the identifier of a current page underlined by the scroll line. Scroll element control 710 typically provides a scroll element. The scroll element is generally used in conjunction with the scroll line for navigation through the pages. In an embodiment the pages may be either part of a single document, multiple documents, or arranged in a hierarchical data structure. The scroll element is designed to slide across the segments on the scroll line. Each position of the scroll element on the scroll line typically selects exactly one segment and thus exactly one page. The scroll element is generally displayed in user interface 704 as being positioned at a segment pointing to the current page.

Document control 714 in conjunction with zoom control 712 provides zoom in and zoom out functionalities for the scroll line. Document control 714 typically causes a range of navigatable identifiers to be displayed on user interface 704 as a first user selection is received through user interface device 706. The first user selection is typically made by a user in the user interface by positioning a mouse cursor over the scroll line, clicking a pointing device (such as a mouse) and dragging the scroll line away from a current position of the scroll line. Each identifier in the list of identifiers is typically placed right above or right below its respective segment on the scroll line. If the scroll line is dragged away from an initial position of the scroll line, zoom control 712 causes the font size of the range of identifiers to gradually increase as the scroll line is dragged away from the initial position. If the scroll line is dragged towards the initial position of the scroll line, zoom control 712 causes the font size of the range of identifiers to gradually decrease as the scroll line is dragged towards the initial position.

Document control 714 on receiving a second user selection through user interface device 706 for selecting an identifier from the list of identifiers, causes navigation from the current page to a page identified by the selected identifier. The second user selection is typically made by placing the mouse cursor over the identifier and clicking a pointing device.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interfaces to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions. For example, the invention may be implemented as a method performed in a client-server network with the execution methods distributed across the network.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. For instance, the detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

What is claimed is:

1. A computer implemented method for navigating through parts of a document, the method comprising:
presenting a user interface with a scroll line comprising a plurality of segments, each segment pointing to a unique part in a document, each of the unique parts being identified by a unique identifier, the scroll line underlining the unique identifier of a current part being displayed in a viewable area;
providing at least one scroll element on the scroll line, the scroll element being operable to navigate between parts of the document by moving it across the segments, each position of the scroll element on the scroll line selecting exactly one segment, the scroll element being positioned at a first segment on the scroll line, the first segment pointing to the current part;
receiving a first user action comprising selecting and dragging an image of the scroll line away from a current position of the scroll line;
changing information being displayed about the scroll line based on the distance between the current position of the image scroll line and an initial position of the scroll line;
receiving a second user action comprising selecting at least a portion of the displayed information; and
displaying a new part in the viewable area based on the selection.

2. The method of claim 1 further comprising:
underlining the unique identifier of the new part with the scroll line; and
changing the position of the scroll element to a segment pointing at the new part.

3. The method of claim 1 further comprising receiving a third user action comprising selecting the scroll line to visually highlight the scroll element.

4. The method of claim 1 wherein selecting at least a portion of the information comprises selecting an identifier from a list of identifiers to navigate to a part identified by the identifier.

5. The method of claim 1 wherein presenting a user interface with a scroll line comprises presenting the scroll line for one or more elements in a breadcrumb navigation.

6. The method of claim 1 further comprising presenting a second scroll line for a portion of the displayed information operable to navigate through a second set of parts, the second set of parts being comprised in a child node of a hierarchical tree.

7. The method of claim 1 wherein changing the information being displayed about the scroll line further comprises:
displaying a range of the unique identifiers pointing to respective parts in the document;
increasing the display size of the range of unique identifiers as the image scroll line is dragged away from the initial position of the scroll line; and
increasing the display size of the image scroll line as the image scroll line is dragged away from the initial position of the scroll line.

8. The method of claim 1 wherein changing the information being displayed about the scroll line further comprises:
decreasing the display size of a range of unique identifiers as the image scroll line is dragged towards the initial position of the scroll line;
decreasing the display size of the image scroll line as the image scroll line is dragged towards the initial position of the scroll line until the image scroll line merges with the scroll line at the initial position; and
stop displaying the list of unique identifiers as the image scroll line merges with the scroll line at the initial position.

9. A user interface for navigating through parts of a document, the user interface comprising:
a scroll line comprising a plurality of segments, each segment pointing to a unique part in a document,
a unique identifier for uniquely identifying each of the unique parts in the document, the scroll line underlining the unique identifier of a current part;
a viewable area for displaying the current part; and
at least one scroll element provided on the scroll line, the scroll element being operable to navigate between parts of the document by moving it across the segments, each position of the scroll element on the scroll line selecting exactly one segment, the scroll element being positioned at a first segment on the scroll line, the first segment pointing to the current part; and
the scroll line being operable to receive a first user action comprising selecting and dragging an image of the scroll line away from a current position of the scroll line and to change the information being displayed about the scroll line based on the distance between a current position of the image scroll line and an initial position of the scroll line.

10. The user interface of claim 9 further comprising receiving a second user action comprising selecting at least a portion of the displayed information for displaying a new part in the viewable area based on the selection.

11. The user interface of claim 9 further comprising a breadcrumb navigation with one or more elements being provided with the scroll line.

12. The user interface of claim 9 further comprising a second scroll line for a portion of the displayed information operable to navigate through a second set of parts, the second set of parts being comprised in a child node of a hierarchical tree.

13. The user interface of claim 9 wherein changing the information being displayed about the scroll line further comprises:
displaying a range of the unique identifiers pointing to respective parts in the document;
increasing the display size of the range of unique identifiers as the image scroll line is dragged away from the initial position of the scroll line; and
increasing the display size of the image scroll line as the image scroll line is dragged away from the initial position of the scroll line.

14. The user interface of claim 9 wherein changing the information being displayed about the scroll line further comprises:
decreasing the display size of a range of unique identifiers as the image scroll line is dragged towards the initial position of the scroll line;
decreasing the display size of the image scroll line as the image scroll line is dragged towards the initial position of the scroll line until the image scroll line merges with the scroll line at the initial position; and
stop displaying the list of unique identifiers as the image scroll line merges with the scroll line at the initial position.

15. A machine-accessible medium that provides instructions that, when executed by a machine, cause the machine to perform operations comprising:
presenting a user interface with a scroll line comprising a plurality of segments, each segment pointing to a unique part in a document, each of the unique parts being identified by a unique identifier, the scroll line underlining the unique identifier of a current part being displayed in a viewable area;
providing at least one scroll element on the scroll line, the scroll element being operable to navigate between parts of the document by moving it across the segments, each position of the scroll element on the scroll line selecting exactly one segment, the scroll element being positioned at a first segment on the scroll line, the first segment pointing to the current part;
receiving a first user action comprising selecting and dragging an image of the scroll line away from a current position of the scroll line;
changing the information being displayed about the scroll line based on the distance between the current position of the image scroll line and an initial position of the scroll line;
receiving a second user action comprising selecting at least a portion of the displayed information; and
displaying a new part in the viewable area based on the selection.

16. The machine-accessible medium of claim 15 further providing instructions which when executed by the machine cause the machine to perform further operations comprising:
underlining the unique identifier of the new part with the scroll line; and
changing the position of the scroll element to a segment pointing at the new part.

17. The machine-accessible medium of claim 15 further providing instructions which when executed by the machine cause the machine to perform further operations comprising receiving a third user action comprising selecting the scroll line to visually highlight the scroll element.

18. The machine-accessible medium of claim 15 wherein selecting at least a portion of the information comprises selecting an identifier from a list of identifiers to navigate to a part identified by the identifier.

19. The machine-accessible medium of claim 15 wherein presenting a user interface with a scroll line comprises presenting the scroll line for one or more elements in a breadcrumb navigation.

20. The machine-accessible medium of claim 15 further providing instructions which when executed by the machine cause the machine to perform further operations comprising presenting a second scroll line for a portion of the displayed information operable to navigate through a second set of parts, the second set of parts being comprised in a child node of a hierarchical tree.

21. The machine-accessible medium of claim 15 wherein changing the information being displayed about the scroll line further comprises:
displaying a range of the unique identifiers pointing to respective parts in the document;
increasing the display size of the range of unique identifiers as the image scroll line is dragged away from the initial position of the scroll line; and
increasing the display size of the image scroll line as the image scroll line is dragged away from the initial position of the scroll line.

22. The machine-accessible medium of claim 15 wherein changing the information being displayed about the scroll line further comprises:
decreasing the display size of a range of unique identifiers as the image scroll line is dragged towards the initial position of the scroll line;
decreasing the display size of the image scroll line as the image scroll line is dragged towards the initial position of the scroll line until the image scroll line merges with the scroll line at the initial position; and
stop displaying the list of unique identifiers as the image scroll line merges with the scroll line at the initial position.
